(19) United States
(12) Patent Application Publication
(10) Pub. No.: US 2023/0403341 A1
(43) Pub. Date: Dec. 14, 2023

(54) SATELLITE INTERNET SYSTEM WITH EDGE-BASED DELIVERY

(71) Applicant: DISH Network Technologies India Private Limited, Bengaluru (IN)

(72) Inventor: Arun PK, Karnataka (IN)

(73) Assignee: DISH Network Technologies India Private Limited, Bengaluru (IN)

(21) Appl. No.: 18/332,445

(22) Filed: Jun. 9, 2023

(30) Foreign Application Priority Data
Jun. 9, 2022 (IN) 202241033009

(51) Int. Cl. H04L 67/568; H04B 7/185; H04L 61/4511

(52) U.S. Cl. CPC H04L 67/568; H04B 7/18513; H04L 61/4511

(57) ABSTRACT

A satellite internet system includes an edge device that services a neighborhood or relatively close terrestrial area. The edge device receives satellite transmissions, and caches at least some of the received content in a disk drive or other local data storage. In some implementations, the data cached in local storage relates to popular media programs or other content that is likely to be requested by multiple customers operating within range of the edge device. The edge device communicates with customer devices in the area via a terrestrial wireless network. Customer devices obtain cached data directly from the edge device via the terrestrial network, when possible, rather than receiving a dedicated stream of the same data via satellite, thereby reducing bandwidth consumption on the satellite link.

### PRIORITY CLAIM

This application claims priority to India Provisional Application Serial No. 202241033009 filed with the India Patent Office on Jun. 9, 2022. That application is incorporated herein by reference.

### TECHNICAL FIELD

The following generally relates to satellite data communications. More particularly, the following discussion relates to systems, devices and automated processes for improving satellite data communications through the use of an edge communications system having local data storage and terrestrial wireless communication capabilities.

### BACKGROUND

Satellite Internet systems continue to be widely deployed and used. Rural areas, in particular, make wide use of satellite communications to receive television programming, Internet and other data communications services, and the like. Modern satellite communications provide sophisticated and robust delivery of information, entertainment, web browsing and the like to millions of users around the world.

Satellite communications, however, are known to have an inherent technical challenge with signal latency. In the case of geo-synchronously orbiting satellites, for example, the distance for the signal to travel into space and back to earth can be significant, taking half a second or so to complete even at the speed of light. As a result of this inherent feature in satellite communications, a user at a remote end of the satellite connection can experience significant delays for certain tasks. U.S. Pat. No. 8,285,870, for example, describes inherent latency that can occur with domain name services (DNS) requests placed over satellite communications links. Other services (e.g., gaming, media streaming, etc.) can be similarly affected by the lag typically experienced with satellite communications. Further, many satellite customers are restricted by data access limits (e.g., limits imposed by a government or service provider) that can cap the amount of data that is delivered to that user during a day, month or other period of time. If the customer's data usage exceeds their allocated cap, then the user's experience can be undesirably degraded or even blocked until a later time. This frequently causes satellite customers to limit their usage of media streaming or other higher-bandwidth functions, especially when service caps are imposed on excessive usage.

It is therefore desirable to create systems, devices and automated processes that make efficient use of bandwidth allocated to satellite customers, and/or that otherwise improve the satellite user experience. These and other features are described in increasing detail below.

### BRIEF SUMMARY

According to various embodiments, a satellite communications system includes an edge device that services a neighborhood or other relatively close terrestrial area. The edge device receives satellite transmissions and caches at least some of the received content in a hard drive or other local non-transitory data storage. In some implementations, the data cached in local storage relates to popular media programs (e.g., television broadcasts, movies, etc.) that will be of interest to more than one viewer. The edge device communicates with customer devices in the area to deliver cached content directly via a terrestrial wireless network, such as an IEEE 802.11 local area network (LAN), thereby reducing the amount of redundant traffic that would otherwise be transmitted via the satellite. In some implementations, the edge device has access to a larger satellite antenna and/or a more powerful transmitter than the customer devices to thereby support better resilience to rain, snow or other inclement weather. The more powerful transmitter may also provide a more reliable transmit channel than would otherwise be available using only the resources of the customer device. The use of an edge device therefore permits more efficient data transmission of popular content amongst multiple customers.

The edge device may be implemented in any manner. To provide just a few examples, selection between satellite and cached delivery may be managed by the edge device or by the customer device. Other embodiments may use the edge device for access to a shared satellite connection if the customer device does not support or have access to its own satellite connection.

One example embodiment provides an automated process performed by a processor of an edge device in a satellite communications system. The automated process suitably comprises: receiving, via a satellite link, a plurality of media programs; storing the received media programs in a data storage associated with the edge device; subsequently receiving, from a customer device via a local area network that is separate from the satellite link, a request for a media program; and if the requested media program matches one of the received media programs stored in the data storage, obtaining the requested media program from the data storage and transmitting the obtained media program to the customer device via the local area network, and otherwise indicating to the customer device via the local area network that the requested media program is not available from the edge device.

Other embodiments provide an edge device comprising a processor, a non-transitory data storage, a first interface for satellite communications with a satellite via a satellite link and a second interface for wireless terrestrial communications via a network that is separate from the satellite link. The non-transitory data storage stores computer-executable instructions that, when executed by the processor of the edge device, perform an automated process to receive and cache certain content for later transmission to one or more customer devices via the second interface. In one example, the automated process suitably comprises: receiving, via the first interface, a plurality of media programs; storing the received media programs in the non-transitory data storage; subsequently receiving, from a customer device via the second interface, a request for a media program; and, if the requested media program matches one of the received media programs stored in the data storage, obtaining the requested media program from the non-transitory data storage and transmitting the obtained media program to the customer device via the second interface, and otherwise indicating to the customer device via the second interface that the requested media program is not available from the edge device.

Still other embodiments provide a customer device comprising a processor, a non-transitory data storage and an interface to a terrestrial wireless network for communicating with an edge device. The non-transitory data storage stores computer-executable instructions that, when executed by the processor, perform an automated process. In one example, the automated process suitably comprises: receiving, by the customer device, a user selection of a selected media program; if the selected media program is available from an edge device in communication with the customer device via the terrestrial wireless network, obtaining the selected media program from the edge device via the terrestrial wireless network; and if the selected media program is not available from the edge device, obtaining the selected media program via a satellite communications system.

In some embodiments, the customer device suitably receives a list of programs by the customer device via a satellite link providing communication to the satellite communications system, wherein the list of programs describes media programs stored in a local data storage associated with the edge device. The customer device suitably determines if the selected media program is identified in the list of programs and, if so, requests the selected media program from the edge device via the terrestrial wireless network. The selected media program is otherwise requested via the satellite link. In other embodiments, the customer device identifies the selected media program to the edge device via the terrestrial wireless network so that the edge device determines if the selected media program is available from the edge device. Still other embodiments use the edge device to obtain programs via its own satellite link that can be relayed to the customer device via the terrestrial wireless network.

These and other example embodiments are set forth in increasing detail below.

### DRAWING FIGURES

FIG. 1 shows an example of a satellite system in which an edge system caches certain data for terrestrial delivery to multiple customer devices.

FIG. 2 describes an example process to deliver cached content via an edge device, with delivery selection being handled by the customer device.

FIG. 3 describes an example process to deliver cached content via an edge device, with delivery selection being handled by the edge device.

FIG. 4 describes an example process to deliver cached content to an edge device, with delivery selection being handled by the edge device without usage of a customer uplink.

### DETAILED DESCRIPTION

The following detailed description is intended to provide several examples that will illustrate the broader concepts that are set forth herein, but it is not intended to limit the invention or the application and uses of the invention. Furthermore, there is no intention to be bound by any theory presented in the preceding background or the following detailed description.

According to various embodiments, a satellite communications system includes an edge device that services a neighborhood or relatively close terrestrial area. The edge device receives satellite transmissions, and caches at least some of the received content in a hard drive or other local non-transitory data storage. In some implementations, the data cached in local storage relates to popular media programs (e.g., television broadcasts, movies, etc.). The edge device communicates with customer devices in the area via a wireless network, such as an IEEE 802.11ay local area network (LAN), although other embodiments may use other wireless networking technologies. If desired, the edge device may have access to a larger satellite antenna and/or a more powerful transmitter than the customer devices, thereby providing for better resilience to rain, snow or other inclement weather. The more powerful transmitter may also provide a more reliable transmit channel than would otherwise be available using only the resources of the customer device.

Customer devices suitably obtain cached data directly from the edge device, when possible, rather than receiving a dedicated stream of the same data via the satellite. This arrangement conserves satellite broadcast bandwidth by delivering the data to multiple customers via a single broadcast on the satellite link, which can be scheduled for a convenient time if desired (e.g., at night, or any other time that the satellite link is otherwise relatively idle). The arrangement also reduces each customer's bandwidth consumption on the satellite link, which can help ease limits imposed by data caps or network equality requirements while still allowing the customer access to desired data. Delivery via the terrestrial network could also provide a better viewer experience with reduced buffering in comparison to typical satellite delivery, if desired.

This general concept may be implemented in any number of different ways. In some embodiments, cached data available from the edge device is identified to each customer device through satellite transmissions delivered directly to the customer device. The customer device maintains a listing of cached content, and selects between satellite delivery and terrestrial delivery as appropriate. In other embodiments, the edge device notifies each of its customer devices of cached content that is available from the satellite, again allowing the customer devices to intelligently request cached content directly from the edge device when available. Still other embodiments could route all content requests through the edge device, which then has a router function that delivers locally-cached data when available, and that redirects the customer device to the satellite connection if a locally-cached copy is not available. Alternatively, the edge device could communicate with the satellite control to arrange for a satellite delivery of the requested data directly to the customer device. In still another embodiment, the edge device receives the requested data via the satellite and forwards the received data to the customer device via the terrestrial network. Other embodiments could be implemented in many equivalent ways, as desired.

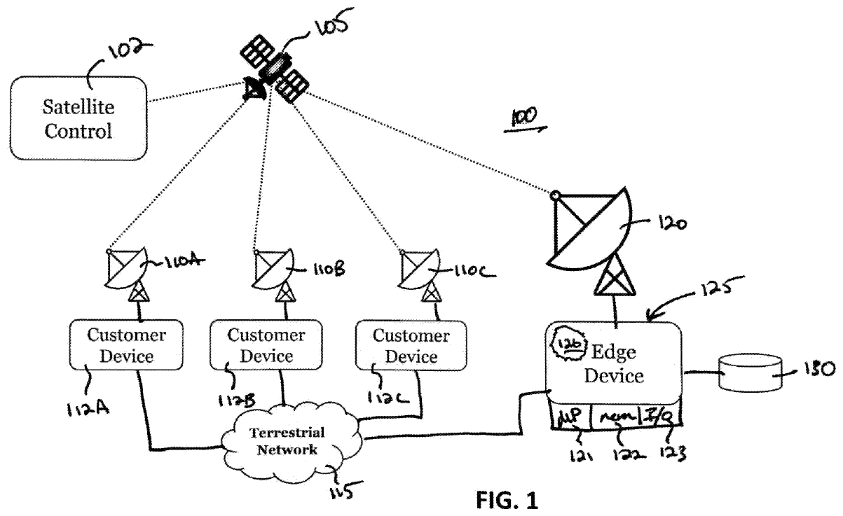

With reference to FIG. 1, an edge device 125 operating within a satellite communications system 100 permits local storage of popular content that can be accessed by any of the customer devices 112A, 112B, 112C operating within a neighborhood or other relatively close geographic region. In the example of FIG. 1, customer devices 112A-C communicate with edge device 125 via a wireless local area network (WLAN) 115 such as an IEEE 802.11 WLAN, although other embodiments may make use of 5G or other cellular communications, citizens broadband radio service (CBRS), and/or any other wireless communications systems that may be available.

In one example embodiment, WLAN 115 is implemented as an IEEE 802.11ay network that is hosted by the edge device 125, although other implementations could use other network technologies and/or separate WLAN host devices, as desired. IEEE 802.11ay has a range of approximately 500 meters or so, thereby allowing for dozens (or even hundreds!) of customer devices 112A-C operating in range of the edge device 125 to share a common source of data and/or communications, as described more fully herein. Other embodiments using other network technologies (including other IEEE 802.11 technologies) could facilitate sharing of an edge device 125 amongst any number of customer devices 112A-C across any geographic region supported by the terrestrial network. Typically, however, the WLAN 115 will focus on customers within a relatively small geographic footprint in comparison to the satellite service, generally under 1 km or so in radius, often within a few hundred meters or so in radius, or within an area of about 75-100 hectares (185-250 acres) or so. Again, actual service dimensions will vary from embodiment to embodiment depending upon the WLAN capabilities that are available, as well as any attenuation from weather, geography, buildings and/or the like.

Satellite system 100 is any sort of satellite internet system capable of providing internet or similar network services to customer devices 112A-C via a satellite 105. Satellite 105 is typically a human-constructed spacecraft that orbits the earth, often in a geostationary orbit, as with the HUGHESNET satellite service operated by Hughes Network Systems of Germantown, Maryland and others. Other satellites 105 (e.g., the STARLINK satellites operated by SpaceX Corp. of Hawthorne, California) are not necessarily geostationary, but they may make use of equivalent edge device and caching features as described herein. Generally, an operator of satellite system 100 will provide a satellite control service 102 executing on a computer server or the like that controls operations of system 100. Satellite control 102 will typically manage the storage of distributed cached content, and may also provide routing, DNS, quality-of-service (QoS) and/or other services on the satellite network as appropriate.

Customer devices 112A-C are customer-operated computing devices that provide internet services to a home or other single customer. Customer devices 112A-C will each have conventional computing hardware capabilities, including one or more processors, memory or other non-transitory data storage, and appropriate communication interfaces for communications with network 115 and satellite 105. Customer devices 112A-C are typically located on-premises at a customer's home, business or the like, and are designed for easy configurability by non-professional operators. In some implementations, customer devices 112A-C will include a WLAN access point that permits the customer device 112 to provide internet access to the customer's personal devices (e.g., home computers, mobile devices, home appliances, tablets, set top boxes, media streaming devices and/or the like). In other embodiments, one or more customer devices 112A-C are implemented within set top boxes, media streaming appliances, personal computers, mobile devices or the like that directly communicate on WLAN 115 without necessarily relaying communications to other devices within the home or other customer premises.

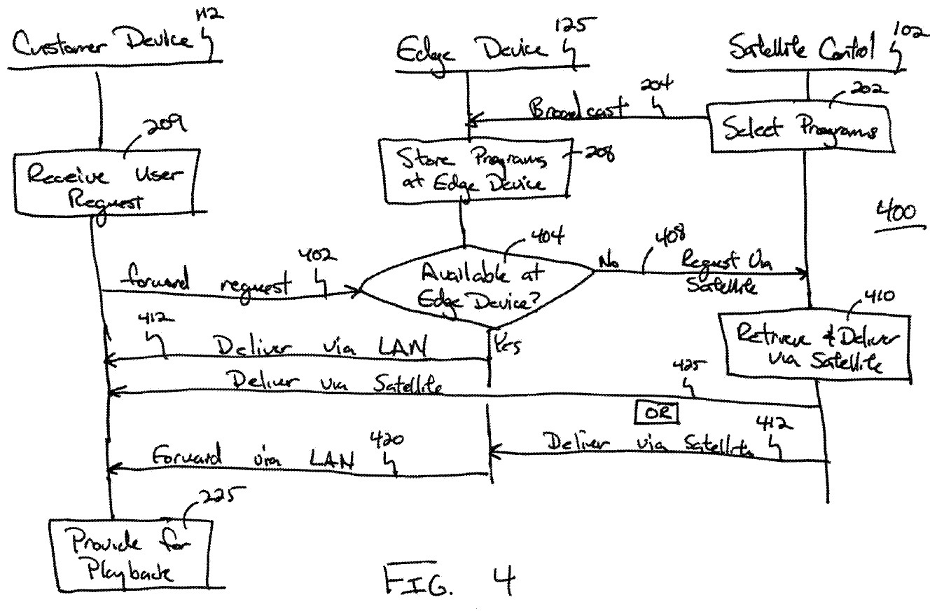

In the example of FIG. 1, each customer device 112A-C operates with a corresponding satellite antenna 110A-C that provides transmit and receive communications with one or more satellites 105. In some embodiments, one or more of the antennas 110A-C could be configured for downlink-only communications, if desired, with uplink communications for at least certain functions (e.g., media streaming) being handled via edge device 125. FIG. 4 below describes an example system in which customer devices 110 rely upon a centralized uplink provided by edge device 104. In still other embodiments, edge device 125 may provide a “backup” capability if the customer device antenna 110 is unable to effectively communicate due to weather (e.g., rain or snow), or for any other reason.

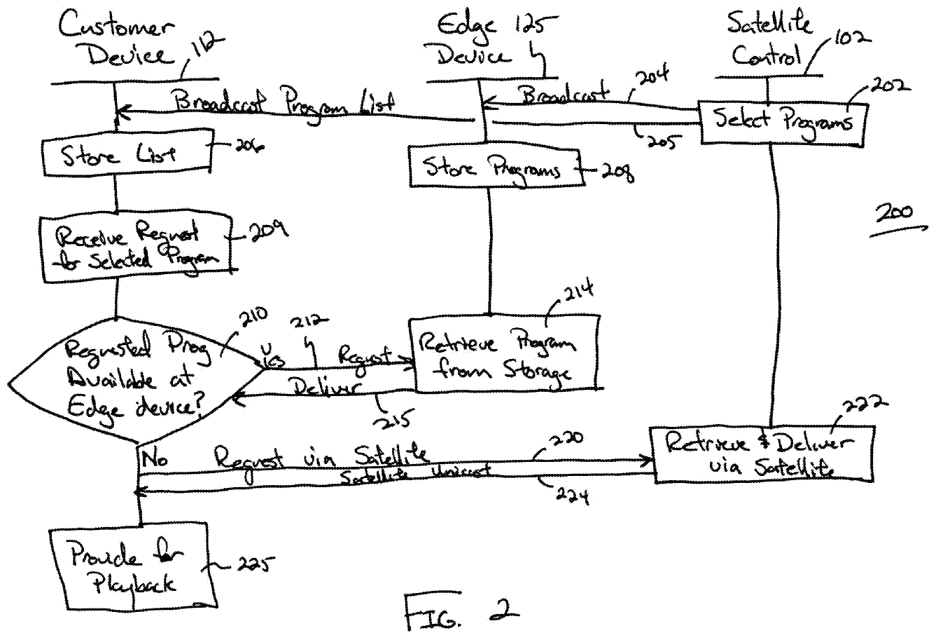

Edge device 125 is any computing device capable of operating substantially as described herein. Generally, edge device 125 is based upon a computing platform that includes one or more processors 121, memory or other non-transitory data storage 122 and appropriate input/output interfaces 123. In one example, edge device 125 is based upon a personal computer platform executing any variant of the LINUX operating system, although equivalent embodiments could be built upon any other operating system and/or hardware platform that may be available. Edge device 125 may operate under control of a firmware or software image that is provided, e.g., by satellite control system 102 and that provides a control application 126 made up of computer-executable instructions stored in data storage 122 for execution by processor 121 to implement the various functions described herein (e.g., the various functions of FIGS. 2-4). Application 126 will typically include modules for receiving and storing cached media content or other data. Application 126 may also include functionality for providing a DNS service, web hosting service, content delivery network (CDN) and/or the like to perform the various functions described herein. Other embodiments may supplement or modify this capability in any manner.

Edge device 125 will typically include a WLAN interface that may host network 115, or at least allows edge device 125 to communicate with the various customer devices 112 supported by the edge device 125. Edge device 125 may also include a satellite communications interface to antenna 120 for communications with satellite 105. As mentioned previously, edge device 125 may be located in a central area (e.g., a rooftop, cellular network site, public access site, leased location, and/or the like) that permits larger and/or more sophisticated antennas 120 than would ordinarily be used for customer devices 110A-C. Additionally, more powerful transmission capabilities may be available at a centralized location, which can make the edge device 125 more reliable for uplink communications than customer devices 112 in some situations.

Edge device 125 typically includes, or at least communicates with, a non-transitory storage device 130 that can be used to store cached data received via satellite 105. In various embodiments, storage device 130 is a hard drive that uses magnetic, optical and/or solid state technologies to reliably store data for subsequent retrieval. In some examples, storage device 130 is an internal or external solid state or magnetic drive that communicates with edge device 112 via a high-speed bus connection (e.g., a PCI or USB bus) for rapid data retrieval. Storage device 130 may represent multiple drives (e.g., an internal solid state drive along with one or more external disk drives) in some implementations.

Edge device 125 allows certain content to be cached locally in storage 130 so that customer devices 112A-C can obtain the cached content via WLAN 115 rather than via satellite 105. Local delivery from a cached copy can support lower latency in comparison to delivery via satellite 105 in some instances. A substantial benefit of the cached copy, however, is that the cached content can be delivered to multiple customer devices 112A-C when requested by users of those systems without using additional bandwidth on satellite 105. Moreover, the data can be broadcast for caching at a time that the system 100 is otherwise relatively idle, thereby making very efficient use of the satellite bandwidth. In some implementations, a single satellite broadcast can be simultaneously transmitted to multiple edge devices 125 (e.g., all of the edge devices 125 operating within the broadcast footprint of the satellite 105), thereby further reducing the bandwidth used to distribute the data. That is, rather than transmitting separate streams of a popular media program to dozens (or even hundreds or more) of different customer devices via satellite 105, a single broadcast can be used to distribute the same content to the same customers from one or more edge devices 125. The scale of bandwidth savings will vary based upon the popularity of the cached data and the scope of the implementation, but substantial system-wide bandwidth savings may be realized. Moreover, each customer's bandwidth allocation for data traversing satellite 105 can be conserved by using terrestrial delivery, thereby preserving that allocation for other purposes, if desired.

As noted above, certain content is locally cached in storage 130 of edge device 125. Each customer device 112 obtains cached content from the edge device 125 via the terrestrial wireless network 115. Content that is not available from the local cache is retrieved for delivery via satellite 105, as appropriate. Selection between terrestrial and satellite delivery may take place in any manner, and routing intelligence may be allocated between the customer devices 110A-C, edge device 125 and/or satellite control 102 in any manner.

FIGS. 2-4 provide several different examples of routing arrangements that could be formulated to permit the customer equipment 110 to obtain content from either edge device 125 and/or via satellite 105. The various techniques shown in FIGS. 2-4 could be combined in any manner, if desired. Other embodiments may use different processes other than those shown in these examples. The particular functions that are shown in FIGS. 2-4 may therefore be supplemented, modified, combined and/or otherwise arranged in other ways to construct a wide range of alternate but equivalent embodiments.

FIG. 2 shows one example process 200 to distribute media programs or other data to customer devices 112 via an edge device 125 associated with a satellite communications system 100. In the example of FIG. 2, each customer device 112 receives a listing 205 of cached programs from the satellite control system 102 (or another source via satellite 105) to permit the customer device 112 to intelligently request data from the edge device 125 or via the satellite 105, as appropriate. The program list 205 may be simultaneously broadcast to multiple customer devices 112A-C via satellite 105, if desired.

Satellite control 102 suitably selects programs or other data for caching on edge device(s) 125 in any manner (function 202). Data may be selected with regard to popularity (or expected popularity) of the data, or in any other manner. In one example, media programs that are recognized to be popular or that are expected to be popular (e.g., sporting events, movies, television programs, streaming videos, etc.) can be distributed to the various edge devices 125 via a satellite broadcast 204. Each edge device 125 receiving the broadcast 204 stores the received data in storage 130 for subsequent retrieval (function 208) by one or more customer devices 112A-C.

In the example of FIG. 2, satellite control 102 also transmits a listing 205 of the programs that are stored in the cache to permit the customer device 112 to make subsequent decisions about requesting programs. In various embodiments, the list 205 is simultaneously broadcast via satellite to each of the customer devices 112 having access to the cached data. List 205 may also include address information (e.g., universal resource locators (URLs), IP addresses and/or the like) that will allow the customer device 112 to subsequently obtain the cached data. Customer devices 112 locally store the list 205 received via satellite 205 in any manner (function 206). This allows each customer device 112 to have its own listing of programs or other data that has been cached with the local edge device 125, as appropriate.

When a user of customer device 112 subsequently requests a media program or other data (function 209), the customer device 112 determines whether the requested data is available via the WLAN 115 or via satellite 105 by querying the previously stored copy of list 205 (function 210). If the content appears in the copy of list 205, then the content is available from edge device 125 and can be streamed or otherwise delivered via WLAN 115. If this is the case, then the relevant data it is appropriately requested 212 via WLAN 115. WLAN 115 suitably retrieves the requested data from storage 130 (function 214) and delivers the requested data as a media stream or the like back to the customer device 112 via WLAN 115 (function 215).

Content may be streamed in any manner. In various embodiments, adaptive streaming techniques may be used wherein a media player (or customer device 112) requests segments of a stored media stream that have been encoded at different qualities. Other embodiments may provide media streams without necessarily adapting the quality of the stream during the streaming session. Still other embodiments may simply transfer a data file using, e.g., file transfer protocol (FTP) or the like, or using conventional hypertext transport protocol (HTTP) GET constructs. Other embodiments could be constructed using other streaming or other file transfer techniques as desired.

If the customer device 112 does not find the requested content in the list 205, the content can be assumed to be unavailable from the local cache at edge device 125. The content is therefore requested via satellite 105 (function 220). In this case, the satellite control system 102 obtains the requested data from the Internet or the like, and delivers the requested data via satellite 105, as appropriate (function 224). Control system 102 may alternatively obtain requested content from a media store or the like, and may deliver the content using any streaming, file transfer or other constructs.

The requested content is received from edge device 125 or via satellite 105 and rendered for presentation to the user in any manner (function 225). If the requested content is a media program, then the data can be rendered for presentation via a media player application executing on the user's phone, computer, media player or another device. Other types of data may be rendered via a web browser or other interface, as desired.

In this example, content source selection between the edge device 125 and satellite 105 may be handed by routing software in the customer device 112. In other embodiments, selection and management of cached content vis a vis satellite content may be managed in a media application executed on a media player, mobile phone, personal computer or other device that uses customer equipment for internet access. Other embodiments could perform this customer-selection feature in any other manner.

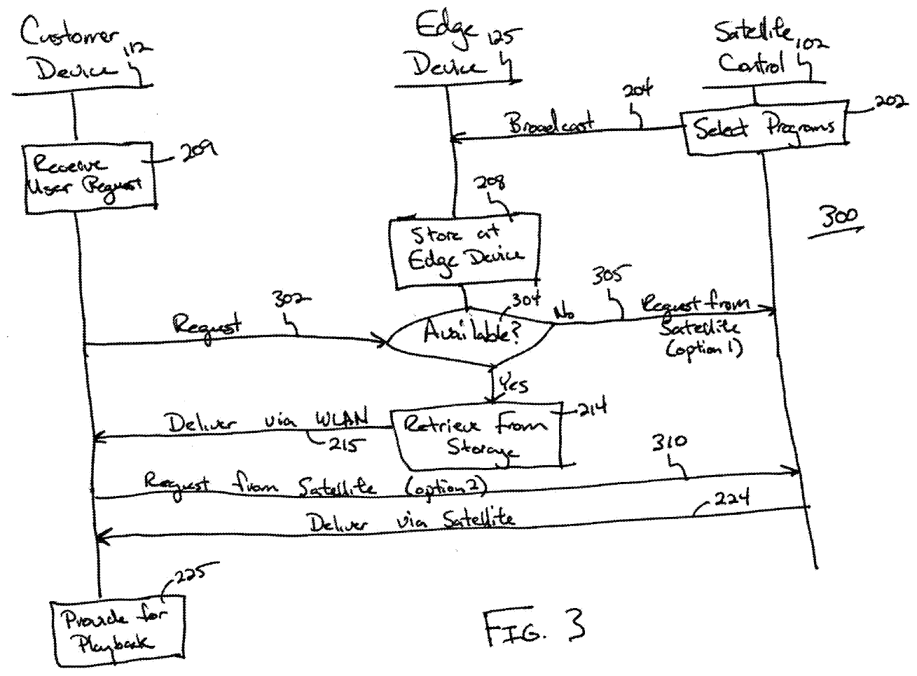

FIG. 3 shows a different example 300 wherein the edge device 125 identifies the cached content to the customer device 112. In this example, the satellite control 102 selects and broadcasts content for caching by one or more edge devices 125, as described above (functions 202 and 204). In this example, however, the customer device 112 forwards all of the content requests 209 received from the user to the edge device 125 via WLAN 115 (function 302). Edge device 125 determines whether the requested content is previously cached in local storage 130 (function 304). If so, the requested content is retrieved from storage 130 (function 214) and delivered via WLAN 115 to the requesting device 112, as noted above (function 215). As with the prior example, content may be delivered using any desired streaming and/or file transfer technique.

If the requested content is not available via the local cache in function 304, several options are available for further processing. In a first example, the edge device 125 forwards the content request via satellite 105 to satellite control 102, which is able to obtain the content and deliver it directly to the originally-requesting customer device 112 (function 310) via satellite 105. This technique can be useful if the customer device 112 lacks an uplink capability that would permit direct transmission from customer device 112 to satellite 105.

If the customer device 112 has an uplink capability, then edge device 125 could simply respond to the request 209 via the WLAN 115 to indicate to the customer device 112 that the content is not available in local cache 130. This would prompt the customer device 112 to make its own direct request 310 for the requested content via the uplink to satellite 105. Alternatively, edge device 125 could place an uplink message directing the control system 102 to obtain the requested content and to transmit the obtained content to the appropriate customer device 112. Whether the edge device 125 or the customer device 112 transmits the uplink request via satellite 105, the requested data would be delivered directly to the customer device 112 via downlink from satellite 105 (function 224) for playback or otherwise rendering to the user as described above (function 225).

Turning now to FIG. 4, yet another embodiment of an automated process 400 could reduce (or even eliminate) the need for uplink (and optionally downlink) capabilities in the customer device 112. This technique could be used as a primary internet system that allows multiple customers to share a common satellite connection, if desired. Alternatively, process 400 could be used in a backup capacity when weather, repairs or other conditions limit the customer's capability for its own uplink and/or downlink satellite communications. Put another way, the delivery technique of FIG. 4 could be used as a temporary (or permanent) replacement for the techniques of FIGS. 2-3 if the uplink or downlink capabilities of one or more customer devices 112A-C become unavailable.

In the example of FIG. 4, the customer's device 112 forwards all requests 210 for content to the edge device 125 via WLAN 115, as in the previous example. If the content is available in storage 130 (function 404), then the edge device 125 retrieves the cached content and delivers it via WLAN 115 (function 420) as described above. If the requested content is not available locally (function 404), then the edge device 125 requests the content via satellite 105 using its own uplink capability (function 408). The satellite control center 102 retrieves (function 410) and delivers the content via the satellite antenna 120 that is associated with the edge device 125 (function 412). Edge device 125 then forwards the received data/media stream to the customer device 112 via the WLAN 115, thereby eliminating the need for the customer device 112 to communicate directly with the satellite 105 via its own antenna 110. In another example, the edge device 125 uses its uplink capabilities to forward the content request to the satellite center 102 (function 408), but the satellite delivers the requested content/stream directly to the customer device 112 via its own antenna 110 (function 425), if available. Once again, the customer device 112 forwards the received data for presentation to the viewer in any appropriate manner (function 225).

As noted above, the examples shown in FIGS. 2-4 may be modified or supplemented in any manner. In a practical embodiment, requesting and routing may occur in an application executed by a customer's computer, media player, phone or other device, for example, with the customer device 112 forwarding data for processing as indicated herein. Other embodiments may function in any other manner.

Still other embodiments may make use of DNS constructs to direct HTTP or similar traffic from customer devices 112A-C toward the appropriate locations of requested content, as desired. DNS services, for example, could be used to point customer device 112 requests for certain content to the most appropriate source for delivering that content. DNS services may be provided anywhere within the satellite system 100 (e.g., by satellite control 102), for example, and/or by the edge device 125 if desired. Any DNS service that responds to DNS queries from customer equipment 112 could be configured with the local addresses of programs stored in cached storage 130 so that subsequent requests (e.g., HTTP “GET” commands or the like) for the content from the customer device 112 are addressed directly to the host (e.g., edge server 125) that is able to obtain and deliver the content in the most efficient manner. To that end, it may not be necessary to provide unique coding or processing logic to each customer device 112 if the customer devices 112 are otherwise configured to use a DNS service that is aware of the content stored in local cache 130 and is able to deliver a network address associated with that content for subsequent use by the customer device. Other embodiments may use DNS constructs similar to those used in content delivery networks (CDNs), and/or the like.

In operation, then, satellite communications system 100 uses an edge device 125 to store cached content in a data storage 130 that can be delivered to one or more customer devices 112A-C via wireless LAN 115 or the like. Selection between the edge storage 130 and communications via satellite 105 may be performed by the customer device 110, the edge device 125, a different DNS service and/or any combination thereof.

Note that various example embodiments have been described herein, but many other embodiments could include other processing modules in addition to those illustrated in FIGS. 1-4, and/or may provide the various features and functions described herein using different (but equivalent) arrangements of processing modules and features, as desired.

What is claimed is:

1. An automated process performed by a processor of an edge device in a satellite communications system, the automated process comprising:
receiving, via a satellite link, a plurality of media programs;
storing the received media programs in a data storage associated with the edge device;
subsequently receiving, from a customer device via a local area network that is separate from the satellite link, a request for a media program;
if the requested media program matches one of the received media programs stored in the data storage, obtaining the requested media program from the data storage and transmitting the obtained media program to the customer device via the local area network, and otherwise indicating to the customer device via the local area network that the requested media program is not available from the edge device.

2. The automated process of claim 1 further comprising, if the requested media program does not match one of the received media programs stored by the edge device, the edge device directing the customer device to request the requested media program via the satellite communications system for delivery directly to the customer device via the satellite communications system.

3. The automated process of claim 1 wherein if the requested media program does not match one of the received media programs stored by the edge device, the edge device transmits a message to the customer device via the local area network directing the customer device to request the requested media program for delivery directly to the customer device via the satellite communications system.

4. The automated process of claim 3 wherein the customer device places a request for the requested media program via an uplink from the customer device to the satellite communications system.

5. The automated process of claim 1 further comprising, if the requested media program does not match one of the requested media programs, the edge device requesting the requested media program via the satellite link.

6. The automated process of claim 5 wherein the requested media program is delivered to the customer device via a downlink from the satellite communications system directly to the customer device.

7. The automated process of claim 5 wherein the requested media program is delivered to the edge device via the satellite link for re-transmission of the requested media program to the customer device via the local area network.

8. The automated process of claim 1 wherein each of the plurality of media programs is associated with a unique network address that identifies a location of the media program on the storage device.

9. The automated process of claim 8 wherein the customer device obtains the unique network address of the requested program by placing a domain name services (DNS) query to the edge device.

10. The automated process of claim 8 wherein the customer device obtains the unique network address of the requested program by placing a domain name services (DNS) query via the satellite communications system.

11. An edge device comprising a processor, a non-transitory data storage, a first interface for satellite communications with a satellite via a satellite antenna and a second interface for wireless terrestrial communications via a network, wherein the non-transitory data storage stores computer-executable instructions that, when executed by the processor of the edge device, perform an automated process comprising:
receiving, via the first interface, a plurality of media programs;
storing the received media programs in the non-transitory data storage;
subsequently receiving, from a customer device via the second interface, a request for a media program;
if the requested media program matches one of the received media programs stored in the data storage, obtaining the requested media program from the non-transitory data storage and transmitting the obtained media program to the customer device via the second interface, and otherwise indicating to the customer device via the second interface that the requested media program is not available from the edge device.

12. The edge device of claim 11 wherein if the requested media program does not match one of the received media programs stored by the edge device, the edge device directing the customer device via the second interface to request the requested media program for delivery directly to the customer device via the satellite.

13. The edge device of claim 11 wherein if the requested media program does not match one of the requested media programs, the edge device requests the requested media program via the first interface.

14. The automated process of claim 13 wherein the requested media program is delivered to the customer device via a downlink from the satellite directly to the customer device.

15. An automated process to be performed by a customer device that comprises a processor and an interface to a terrestrial wireless network for communicating with an edge device, wherein the automated process comprises:
receiving, by the customer device, a user selection of a selected media program;
if the selected media program is available from an edge device in communication with the customer device via the terrestrial wireless network, obtaining the selected media program from the edge device via the terrestrial wireless network; and
if the selected media program is not available from the edge device, obtaining the selected media program via a satellite communications system.

16. The automated process of claim 15 further comprising:
receiving a list of programs by the customer device via a satellite link providing communication to the satellite communications system, wherein the list of programs describes media programs stored in a local data storage associated with the edge device; and
determining, by the customer device, if the selected media program is identified in the list of programs and, if so, requesting the selected media program from the edge device via the terrestrial wireless network, and otherwise requesting the selected media program via the satellite link.

17. The automated process of claim 15 further comprising the customer device identifying the selected media program to the edge device via the terrestrial wireless network, wherein the edge device determines if the selected media program is available from the edge device.

18. The automated process of claim 17 wherein the customer device communicates with the satellite communications system via a satellite link that is separate from the terrestrial wireless network, and wherein the edge device is configured to direct the customer device to request the selected media program via the satellite link if the selected media program is not available from the edge device.

19. The automated process of claim 17 wherein the customer device communicates with the satellite communications system via a satellite link that is separate from the terrestrial wireless network, and wherein the edge device is configured to communicate with a satellite control service to instruct the satellite control service to deliver the selected media program directly to the customer device via the satellite link if the selected media program is not available from the edge device.

20. The automated process of claim 17 wherein the edge device is configured to communicate with a satellite control service to instruct the satellite control service to deliver the selected media program to the edge device via the satellite communications service and to forward the selected media program received via the satellite communications system to the customer device via the terrestrial wireless network.
